(19) United States
(12) Patent Application Publication
(10) Pub. No.: US 2017/0335881 A1
(43) Pub. Date: Nov. 23, 2017

(54) Hook Apparatuses and Systems Useful For Hanging and Organizing Articles

(71) Applicant: John Ashman Briggs, Brookville, PA (US)

(72) Inventor: John Ashman Briggs, Brookville, PA (US)

(21) Appl. No.: 15/598,868

(22) Filed: May 18, 2017

Related U.S. Application Data
(60) Provisional application No. 62/338,132, filed on May 18, 2016.

(51) Int. Cl. F16B 45/00; F16M 13/02

(52) U.S. Cl. CPC F16B 45/00; F16M 13/02

(57) ABSTRACT

The present disclosure provides apparatuses that are useful in hanging and/or organizing a diversity of items and materials. The apparatuses may be formed from a single piece of material, thus providing a unitary design that is able to be rapidly and easily deployed. When vertically oriented, the mutli-hook design of the apparatuses provide a useful tool for hanging items such as cords, cables, tools, and clothing. When deployed horizontally, the apparatuses may be used to effectively organize and/or secure items, for example, across a horizontal workspace. The simple design of the apparatuses disclosed herein permits them to be oriented along whatever axis is desired by the user, thus greatly increasing their utility.

### CROSS-REFERENCE TO RELATED APPLICATIONS

This application claims the benefit under 35 U.S.C. §119(e) of the earlier filing date of U.S. Provisional Patent Application No. 62/338,132 filed on May 18, 2016.

### BACKGROUND OF THE INVENTION

### 1. Field of the Invention

The present invention relates generally to providing systems and apparatuses that facilitate the simple and effective hanging, organization, and placement of a wide variety of articles.

### 2. Description of the Background

facilitate organization and effective storage of diverse items, modular and multi-component hanging and storage systems are commonly employed. See, for example, U.S. Pat. Nos. 3,659,722; 6,918,498; and U.S. Pat. No. 6,948,627, which are hereby incorporated by reference. Such systems often require extensive assembly by the user and are commonly limited to implementations in a single, fixed orientation. For example, the wired shelf hooking system disclosed in U.S. Pat. No. 6,918,498 utilizes vertical brackets that may be fixedly secured to a wall or a large frame. Horizontal shelves may be placed into slots in the vertical brackets to establish storage space. Other systems (e.g., U.S. Pat. No. 3,659,722) employ a series of wire hooks that may be integrated via welding into a frame or bracket, which is in turn secured to a wall so as to arrange the hooks horizontally to accommodate different items, such as garden tools, cables, or pans.

The prior art systems, however, do not provide easily fabricated apparatuses that formed from a single piece of material that may be quickly implemented to facilitate organizing and hanging a variety of articles and which also display sufficient strength to support substantial items. The present invention addresses these shortcomings.

### SUMMARY OF THE INVENTION

The present invention addresses the limitations currently existing within the art and provides an apparatus useful for hanging and organizing a wide variety of items, cables, wiring, piping, conduits, and materials. The apparatuses may be utilized in numerous circumstances and permit a user to easily, quickly, and securely manage a wide variety of items and materials.

In one aspect, the present invention provides an apparatus capable of supporting materials and items that includes a spine that runs from the bottom to the top of the apparatus and a series of arm pairs that extend at an acute angle from the spine towards the top of the apparatus. Each arm extends has an edge or perimeter that extends smoothly from the spine towards the top of the apparatus at an acute angle. At a certain distance from the spine, the perimeter of the arm transitions to become approximately parallel to the spine. After extending for an appropriate distance (based on the size hook preferred by the user), the arm ends in a smooth, curved tip, whereupon the edge of the arm extends back towards the bottom of the apparatus, roughly parallel to the spine, thus forming the body of the hook. The edge (or perimeter) of the arm then smoothly transitions back to run parallel to the spine to form a pocket at the base of the hook structure. The corresponding arm on the opposite side of the apparatus shares a parallel shape so that the apparatus includes a pair of arms set at the same height of the apparatus. The apparatus includes a plurality of such pairs of arms with the exact number being established by the user for the circumstances in which the apparatus is to be employed.

In some embodiments, the arms (or hooks) have a curved longitudinal profile, i.e. as viewed from the bottom of the apparatus looking up the spine of the apparatus. In some embodiments, the arms (or hooks) have a semi-circular curved profile. In other embodiments, the arms (or hooks) have a straight longitudinal profile, such that they extend almost as wings at an acute angle from the spine.

In some embodiments, the spine is substantially flat for its entire length, thus permitting the apparatus to fit snugly against a surface, such as a vertical wall. To secure the apparatus to a wall, for example, the spine may include multiple holes that are adapted to accommodate mechanical fasteners. Those mechanical fasteners may be used to secure the apparatus, for example, to a vertical wall. In other embodiments, an adhesive substance (e.g., double-sided tape) may be used to secure the spine (and thus the apparatus) to a surface (e.g., a vertical wall).

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows a profile view of an embodiment of a vertical hanging apparatus of the present invention;

FIG. 2 shows a side-view embodiment of a vertical hanging apparatus of the present invention shown in FIG. 1;

FIG. 3 displays a face view of the embodiment of a vertical hanging apparatus of the present invention shown in FIG. 1;

FIG. 4 displays a rear view of the embodiment of a vertical hanging apparatus of the present invention shown in FIG. 1;

FIG. 5 depicts an end view of the embodiment of a vertical hanging apparatus of the present invention shown in FIG. 1;

FIG. 6 displays a profile view of an embodiment of the present invention;

FIG. 7 shows a side view of the embodiment of the present invention shown in FIG. 6;

FIG. 8 depicts a potential use of the embodiment of the present invention shown in FIG. 6;

FIG. 9 shows an embodiment of the present invention useful for hanging; and

FIG. 10 shows an embodiment of the present invention useful for hanging.

### DETAILED DESCRIPTION OF THE INVENTION

The present invention provides apparatuses and systems that are useful in hanging and/or organizing a diversity of items, and methods of their fabrication. The apparatuses of the present invention are preferably formed from a single piece of material, thus providing a unitary design that is able to be rapidly and easily deployed. When vertically oriented, the apparatuses of the present invention provide a useful tool for hanging items such as cords, cables, tools, and clothing. When deployed horizontally, the apparatuses of the present invention may be used to effectively organize and/or secure items, for example, across a horizontal workspace. For ease of discussion, the embodiments of the present invention will commonly be discussed as “vertical hanging apparatuses,” though, as discussed, they may be utilized in horizontal or any other useful orientation. The simple design of the present invention permits the apparatuses to be oriented along whatever axis is desired by the user, thus greatly increasing their utility.

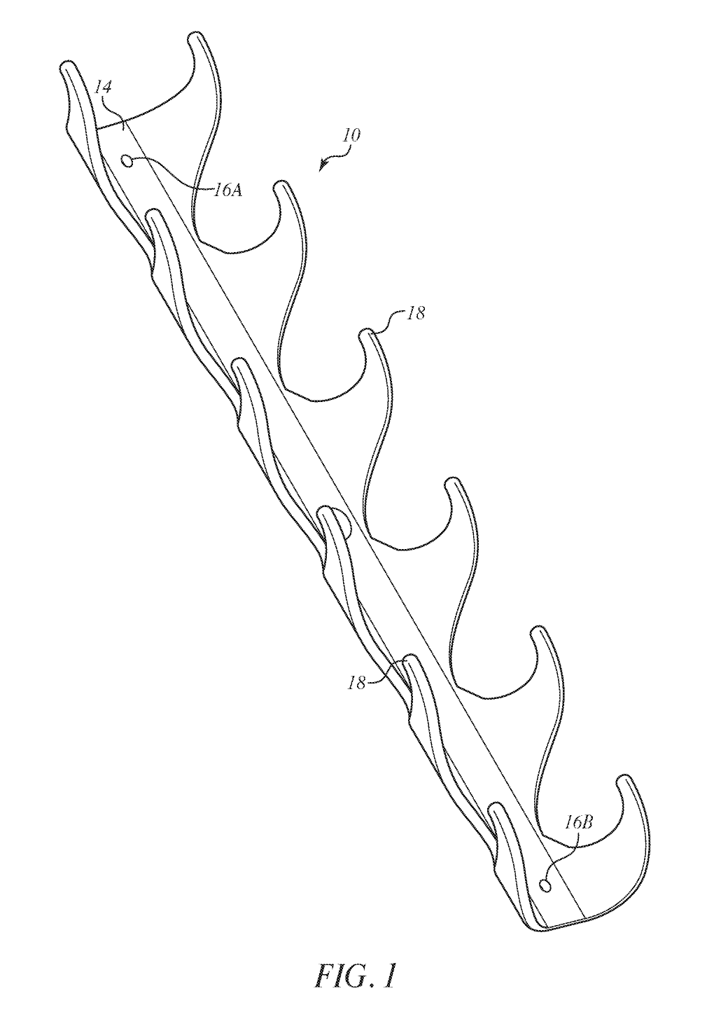

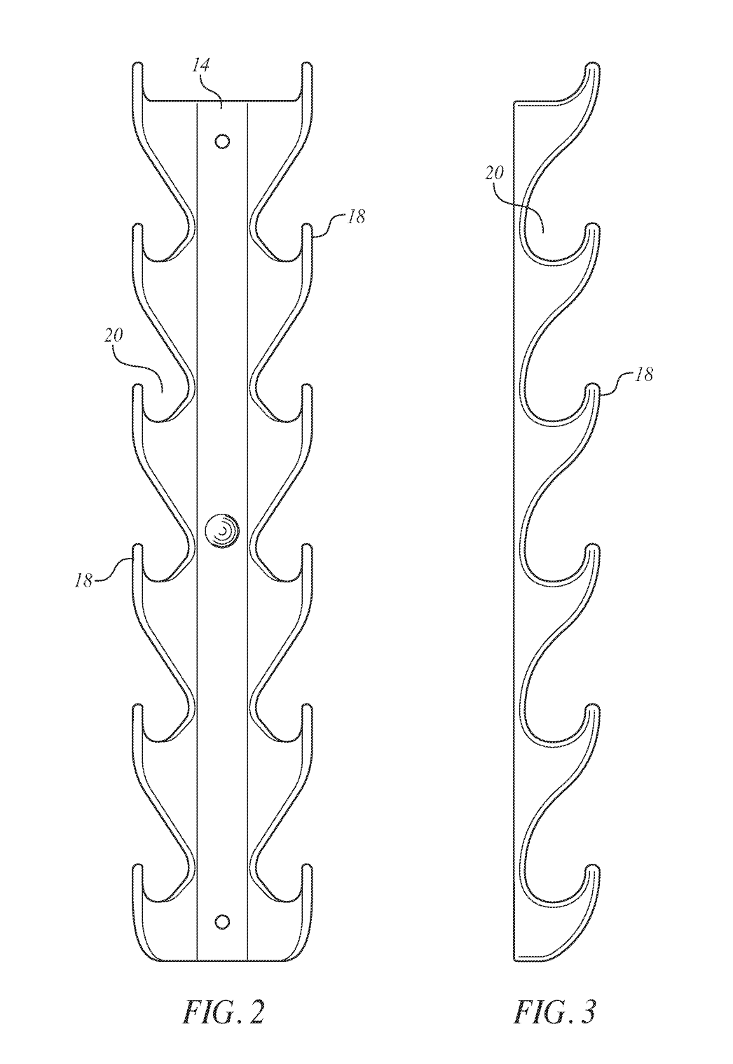

The embodiment shown in FIG. 1 exemplifies some of the numerous advantages of the apparatuses of the present invention. In some embodiments, the present invention may be implemented as a vertical, multi-hook hanging system 10, as shown in FIG. 1. In this embodiment, the apparatus 10 includes a vertical spine 14 that runs the length of the apparatus 10. In some implementations, the vertical spine 14 may be oriented roughly within a vertical plane. In the embodiment shown in FIGS. 1-5, the spine 14 is flat, thus permitting the apparatus 10 to be placed flush with a surface (e.g., a vertical wall).

Generally, the mechanism for securing the spine 14 (and thus the apparatus) to a surface may be dictated by the circumstances in which the apparatuses of the present invention are to be used. For example, the embodiment shown in FIGS. 1-5 includes a spine 14 with two holes 16A, 16B that are capable of accommodating screws, nails, bolts, or other mechanical fastener that may be useful for attaching the apparatus to a surface (e.g., a vertical wall). This permits the apparatuses of the present invention to support substantial items. A mechanical fastener may then be driven into to a vertical surface (e.g., drywall, wood, metal, or a wall stud) such that the apparatus of the present invention may be firmly secured to the vertical surface, sufficient to support heavier items. Similarly, when greater weights are to be supported by the apparatuses of the present invention, a greater number of holes may be employed, thus permitting a greater number of mechanical fasteners to secure the apparatus to the surface (e.g., wall). By way of further example, when the apparatus is to be used to support lighter items, it may be secured by a strip of double-sided, adhesive foam tape. One side of the tape may be stuck to the vertical spine, while the other side of the tape may be secured to the vertical surface (e.g., wall).

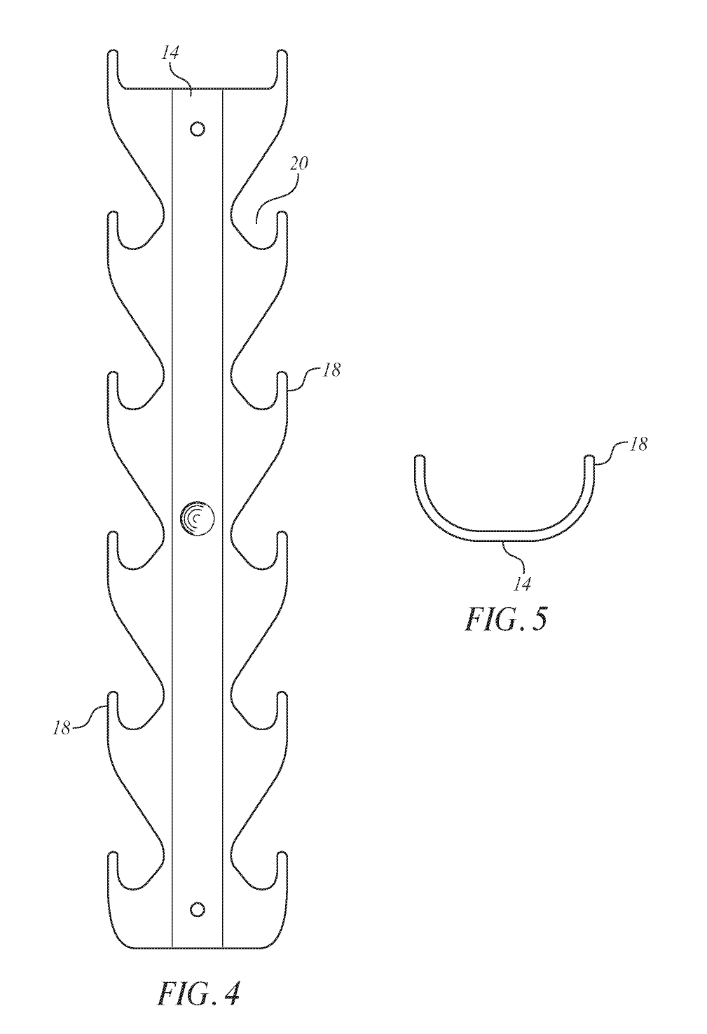

In some embodiments of the present invention, the apparatus 10 also includes a plurality of arms 18 (which may be thought of as hooks) spaced vertically along the length of the spine 14. In the embodiment shown in FIGS. 1-5, pairs of arms 18 extend away from the spine 14 at the same vertical distance along the spine 14, thus creating a vertically oriented array of hook pairs 18. The arms 18 may extend at an acute angle away from the spine, and away from the vertical plane, towards the top of the apparatus. The arms 18, as clearly shown in FIG. 3, may possess a curved profile such that the edge of the arm smoothly transitions from the spine 14 and curves upwards towards the top of the apparatus 10, as shown in the side view shown in FIGS. 1-3.

In some embodiments, the arm terminates at its vertical limit in a curved tip, as shown in FIGS. 1-3, though other shapes for the tip may also be employed. By the arms having this curved profile, a curved nook or pocket 20 is formed between vertically adjacent arms 18 at the base of the top side of the arm. When viewed from the side (as shown in FIG. 3), the nooks on each side of the spine may align to form a horizontal channel-like space 20 in which items (e.g., cables, hoses, cords, tools) may be placed. The size and shape of the channel-like space 20 may be modified by changing the shape and size of the arms 18 to accommodate differently sized items (e.g., a larger channel may be used to store and support larger-diameter tools or hoses). One of ordinary skill in the art will recognize that the geometry and size of the arms 18 and channels 20 formed therefrom may be dictated by the circumstances in which the apparatus is to be employed.

As shown clearly in the end-view of FIG. 5, in some embodiments, the arms 18 of the apparatuses of the present invention may possess a curved longitudinal profile, which in some embodiments is a semi-circular longitudinal profile. Nonetheless, in some implementations of the present invention, the arms possess a straight longitudinal profile, such that each of the arms forms the same angle with the spine. While not wishing to be bound by theory, it is believed that the curved cross-sectional shape of the arms and the fabrication of the apparatus from a single piece of material permit the apparatuses of the present invention to display a superior strength-to-weight ratio sufficient to support heavy items without mechanical failure of the apparatus. Commonly, the limiting factor that determines the load that the apparatuses can carry is the integrity of the mechanism used to secure the apparatus to a vertical wall. For example, if an apparatus fabricated from ⅛ inch thick acrylonitrile butadiene styrene (ABS) is secured to a wall using double-sided tape, the apparatus may support weights of 20 pounds before the tape fails. If, however, the apparatus is secured to a vertical surface by screws, embodiments such as shown in FIGS. 1-5 are able to support weights in excess of 185 pounds without loss of structural integrity.

In yet other implementations of the present invention, the arrangement of arms along the vertical aspect of the spine may be altered. For example, rather than the arms extending from the spine at the same height in pairs, the arms may be vertically staggered from one another. In such implementations, the spine may still be oriented vertically on a vertical surface, but the channel-like space defined by the base of the arms may be slanted at an angle, rather than oriented horizontally. Such an implementation of the present invention may be useful in numerous circumstances, such as when the user wishes to use the apparatuses of the present invention to support and secure a cable that runs diagonally across a wall.

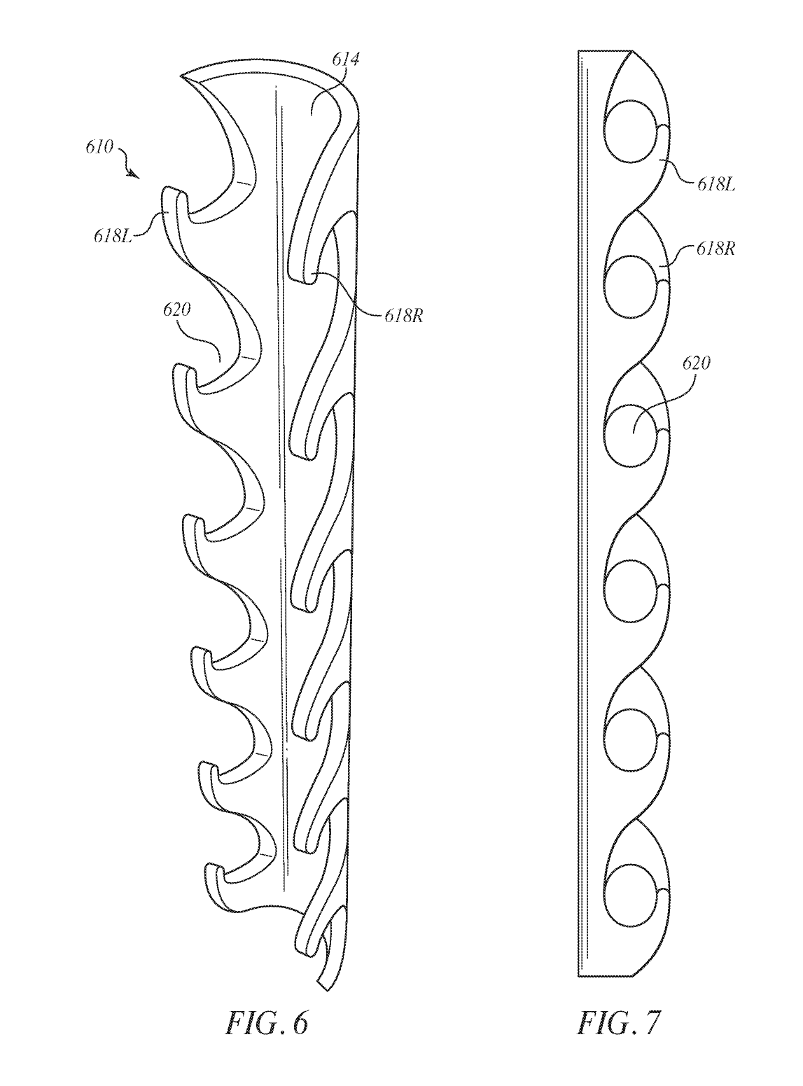

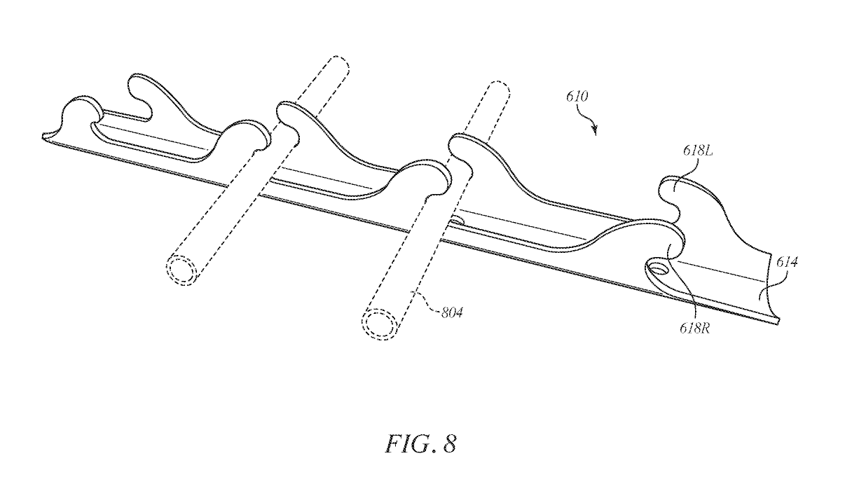

In some circumstances, the user may wish to place an item (e.g., wiring, cable) securely along a particular path, such that the item does not shift due to inadvertent contact. The embodiments of the present invention that have hooks that open solely towards the top of the apparatus may be inappropriate for use for that task because they could too freely permit movement of the item placed on top of those arms. The present invention includes embodiments, such as shown in FIGS. 6-8, that overcome this issue. For example, the embodiment shown in FIG. 6 includes a vertical spine 614 and arms extending from each side of the vertical spine 618L, 618R. In this embodiment, the arms 618L on one side of the vertical spine extend towards the top of the apparatus, while the arms 618R on the other side of the vertical spine extend towards the bottom of the apparatus. Each of the arms 618L, 618R (both upwardly and downwardly extending) form a nook or pocket 620 at the base of the arm. When viewed from the side (FIG. 7), two nooks 620 align to form a channel-like space. Unlike the embodiment shown in FIG. 1 where both arms are open towards the upward side, the arm on one side of the spine firmly secures any item placed in that channel-like space against downward movement, while the arm on the other side of the spine stops the item from freely moving in the upward direction. This embodiment of the present invention may be particularly well employed for locking in items such as tubing, hoses, wiring, or coaxial cable, as shown in FIG. 8, to a particular location.

Embodiments of the present invention, such as those shown in FIGS. 6-8 may be placed on a horizontal surface (e.g., a floor or within a subfloor) to achieve a similar result. In some construction circumstances, tubing may be placed in subflooring as part of a flooring system that provides radiant heat. In those circumstances, the user desires the tubing to remain in the position in which it was originally placed. The spine of the apparatus would thus be placed horizontally within the subflooring so as to accommodate the tubing used in the radiant heat system. When placed in subflooring, these embodiments (e.g., FIGS. 6-8) of the present invention could be used to secure such tubing in a set location.

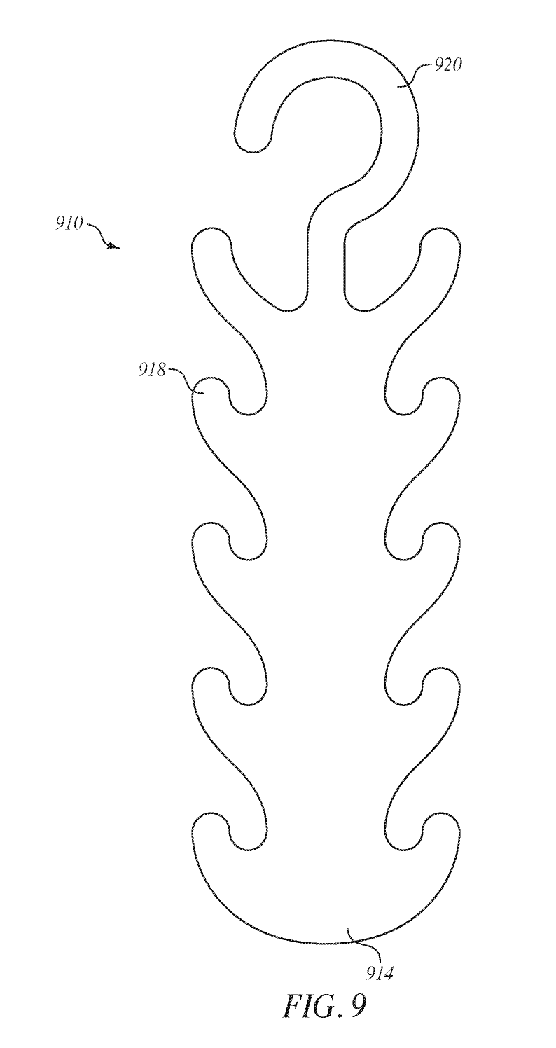

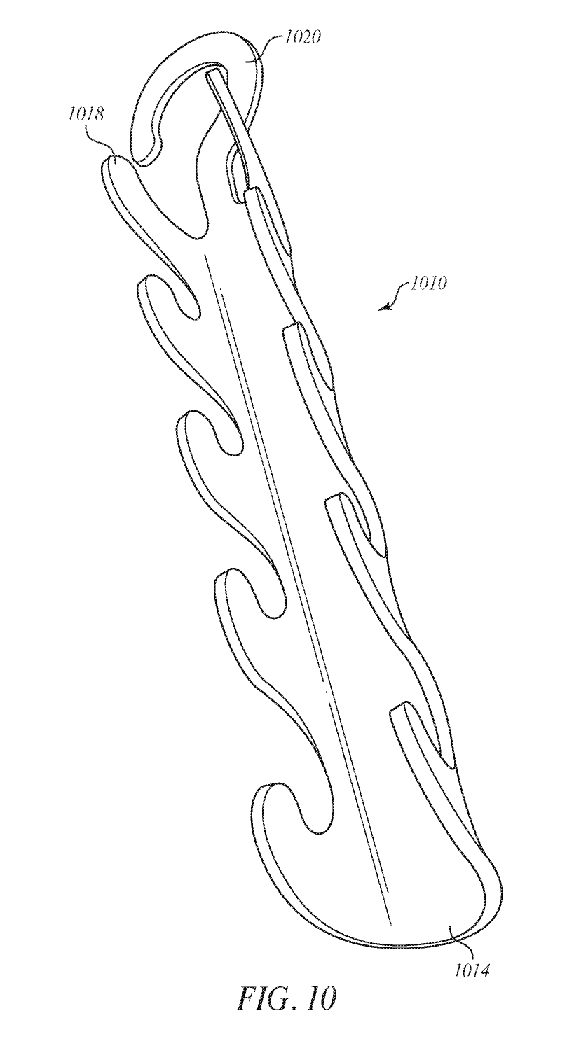

Other embodiments of the present invention (such as shown in FIGS. 9 & 10) are particularly well suited for storing clothing, including for use in closets or other environments where hanging is appropriate. The embodiment shown in FIG. 9 includes a vertical spine 914 having a flat profile, which has arms 918 extending from the spine 914 towards the top of the apparatus 910. In the embodiment shown in FIG. 9, the arms 918 remain in the plane occupied by the spine 914. The apparatus 910 may also include an appropriately sized hook 920 to permit the apparatus 910 to be hung on a rod, such as in a closet. In certain embodiments, the hook 920 is of a shape and size so that it may be placed, for example, over a hanging rod in a closet. The shape and dimensions of this extension from the top of the vertical spine may be altered to interface appropriately with whatever structure the user desires.

Similarly, the embodiment shown in FIG. 10 displays another approach to implementing the apparatuses of the present invention. The apparatus 1010 shown in FIG. 10 similarly has a spine 1014 with pairs of arms 1018 extending therefrom. Unlike the embodiment shown in FIG. 9, where the arms 918 reside in the plane of the spine 914. The arms 1018 of the apparatus 1010 shown in FIG. 10 extend away from that plane (akin to the embodiment shown in FIG. 1). An extension (e.g., a hook-like extension 1020) may similarly be used to permit the apparatus to 1010 to be hung on a horizontal rod, on a hook, in a hole, or in other manners appropriate for the utilization of this embodiment.

For the embodiments shown in FIGS. 9 and 10, the user may easily place the apparatus in a closet, thus permitting the user to hang and organize items such as neckties, belts, hats, and handbags.

As noted, the embodiments of the present invention shown in the attached figures may be employed in a variety of circumstances. For example, when secured to a surface vertically, the apparatus provides a series of paired hooks spaced vertically along the length of the apparatus. Those hooks may be used in a home setting to support and organize clothing, handbags, baseball caps, scarves, kitchen utensils, or similar items. These embodiments of the present invention may also be employed in a work setting to support and organize rope, electrical cords, bungee cords, hoses, or other such items. For implementations where the user wishes to utilize the apparatuses of the present invention to place an item more securely, the embodiment shown in FIGS. 6 and 7 is particularly useful.

In some implementations, several apparatuses of the present invention may be spaced apart from one another across the face of a wall, for example. In this way, the apparatuses could be used to support or organize long items for which a single set of hooks would be insufficient, such as a garden hose or a long tool. In other implementations, several vertically oriented apparatuses could be placed along a route where the user desires to run cable, pipes, electrical wires, conduits, or similar items. In these implementations, the apparatus could be used to support the wiring, for example, across the face of a wall or, in certain construction settings, support the cable, wiring, pipes, etc. within a wall. In other situations, the apparatuses of the present invention may be placed horizontally on a surface (e.g., a floor or in a conduit) to permit the organized distribution and localization of cable, writing, pipes etc. within the floor or conduit. The present invention thus provides a useful tool for organizing, supporting, or maintaining placement of items in a wide variety of circumstances.

The apparatuses of the present invention as shown in the attached figures and as described herein may be fabricated from a diversity of materials. In some implementations, the entire apparatus may be fabricated from a single piece of plastic. The apparatuses of the present invention may be fabricated from any known plastic, including polyvinyl chloride (PVC), thermo-formable plastics or foams, polycarbonate, and acrylonitrile butadiene styrene (ABS). In addition, the apparatuses of the present invention may be fabricated from numerous other materials, including composites, other plastics, wood, and metal, depending on the desires of the user. One of skill in the art will recognize that the particular material and set of properties may be dictated by the circumstances in which the apparatuses of the present invention are to be used.

The apparatuses of the present invention may be fabricated by numerous methods well known to those of ordinary skill in the art, including injection molding and machining. The apparatuses of the present invention may be fabricated using a wide variety of machining tools well known to those of ordinary skill in the art. For example, computer numerical control (CNC) machining tools are particularly well suited for fabrication of the apparatuses of the present invention. A CNC router may be utilized to fabricate two apparatuses of the present invention from a single piece of pipe or tubing in the following manner. The piece of pipe may be secured appropriately into a CNC router which may be used to machine the pipe along its length at a constant feed rate. The pipe is located between two side-mounted routers or high-speed spindles (known in the art as cutters). The left cutter conventionally spins in the clockwise direction and the right cutter conventionally spins in the counterclockwise direction. With the aid of servo motors and by coordinating the feed rate, the cutters will produce a repeating pattern into the side profile of the pipe on both the left and right sides of the tube. Thus, the CNC router may cut the pipe from opposite sides so as to form two separate, but complementary and interlocking, pieces≠each of which may be finished into an apparatus of the present invention. Since the CNC router is capable of cutting each side of the pipe, the pipe need not be flipped over or otherwise disengaged from the CNC router during machining. Additionally, the amount of material wasted in fabrication of embodiments of the present invention utilizing this technique is dramatically reduced.

Nothing in the above description is meant to limit the present invention to any specific materials, geometry, or orientation of elements. Many modifications are contemplated within the scope of the present invention and will be apparent to those skilled in the art. The embodiments described herein were presented by way of example only and should not be used to limit the scope of the invention.

What is claimed is:

1. An apparatus for supporting items and materials, comprising
a spine that extends from a bottom of the apparatus to a top of the apparatus; and
a series of arm pairs that extend at an acute angle from the spine, wherein each arm comprises a perimeter of the arm that defines a lateral profile of the arm,
wherein the perimeter of the arm extends smoothly from the spine towards the top of the apparatus at an acute angle from the spine until a distance from the spine at which point the perimeter becomes approximately parallel to the spine,
wherein the perimeter smoothly transitions to run approximately parallel to the spine and towards the bottom of the apparatus to form an arm having a hook structure,
wherein the perimeter smoothly transitions through a portion that at an acute angle to the spine such that a pocket is formed at the base of the hook structure, and
wherein a corresponding arm extends from the opposite lateral side of the spine thereby creating the arm pair with approximately parallel hooks.

2. The apparatus of claim 1, wherein the spine is substantially flat for its entire length.

3. The apparatus of claim 1, wherein the spine includes holes adapted to accommodate mechanical fasteners used to attach the apparatus to a surface.

4. The apparatus of claim 3, wherein the mechanical fastener is selected from the group consisting of screws, nails, and bolts.

5. The apparatus of claim 1, further comprising an adhesive substance to attach the apparatus to a surface.

6. The apparatus of claim 5, wherein the adhesive substance is double-sided tape.

7. The apparatus of claim 1, wherein the arms possess a curved longitudinal profile.

8. The apparatus of claim 7, wherein the curved longitudinal profile is a semi-circular profile.

9. The apparatus of claim 1, wherein the arms possess a straight longitudinal profile.
